(19) United States
(12) Patent Application Publication
(10) Pub. No.: US 2025/0160318 A1
(43) Pub. Date: May 22, 2025

(54) CRYOPRESERVATION SOLUTION AND USE THEREOF IN REDUCING ISCHEMIA-REPERFUSION INJURY (IRI) OF CELL, TISSUE, OR ORGAN

(71) Applicant: Third Affiliated Hospital, Sun Yat-sen University, Guangzhou (CN)

(72) Inventors: Yang YANG, Guangzhou (CN); Wei LIU, Guangzhou (CN); Qi ZHANG, Guangzhou (CN); Jingxing OU, Guangzhou (CN); Haobin SUN, Guangzhou (CN); Juan SHEN, Guangzhou (CN); Yong JIANG, Guangzhou (CN)

(21) Appl. No.: 18/913,090

(22) Filed: Oct. 11, 2024

(30) Foreign Application Priority Data
Nov. 17, 2023 (CN) 202311544899.9

(51) Int. Cl. A01N 1/02

(52) U.S. Cl. CPC A01N 1/125; A01N 1/162

(57) ABSTRACT

A cryopreservation solution and use thereof in reducing an ischemia-reperfusion injury (IRI) of a cell, a tissue, or an organ, belonging to the technical field of cold storage or cryopreservation. By using innovative exploration mechanisms, it is found that phosphocholine, quinoline-4-carboxylic acid (QCA), and sodium tauroursodeoxycholate (TUDCA) have significant differences during a cryopreservation-rewarming period between hibernating and non-hibernating animals. Based on this, adding the phosphocholine, the QCA, and the TUDCA into a preservation solution to allow cryopreservation of cells, tissues, and/or organs shows a high cell survival rate, can effectively reduce apoptosis caused by cryopreservation-rewarming, reduce mitochondrial reactive oxygen species (ROS), maintain a cell membrane integrity, effectively reduce mitochondrial damage caused by cryopreservation-rewarming, reduce the IRI, and promote liver regeneration. This is of great significance to the advancement of organ transplantation and preservation.

### CROSS REFERENCE TO RELATED APPLICATION

This patent application claims the benefit and priority of Chinese Patent Application No. 202311544899.9 filed with the China National Intellectual Property Administration on Nov. 17, 2023, the disclosure of which is incorporated by reference herein in its entirety as part of the present application.

### TECHNICAL FIELD

The present disclosure belongs to the technical field of cold storage or cryopreservation, and in particular relates to a cryopreservation solution and use thereof in reducing an ischemia-reperfusion injury (IRI) of a cell, a tissue, or an organ.

### BACKGROUND

Cold storage or cryopreservation of cell or tissue is an indispensable key technology in the fields ranging from biomedicine to food industry. Cold storage or cryopreservation preserves biological materials such as living cells, tissues, and organs in a low-temperature or ultra-low-temperature environment, thus greatly slowing down or even stopping metabolism of cell. The common difficulties of cold storage or cryopreservation include: 1) a way to reduce the damage to cells caused by low temperature after cooling; and 2) the restoration for normal functions of cells, tissues, and organs after the temperature is restored.

In recent years, ultra-low-temperature cryopreservation has achieved the cryopreservation of cells and some tissues. The basic principle is to place biological materials such as cells in a vitrified cryopreservation solution to allow equilibrium, and then directly place them in a liquid nitrogen environment to allow water molecules inside and outside the cells to quickly enter a vitrified state. However, there are two major drawbacks to using the vitrified cryopreservation solution. On one hand, vitrification requires a large amount (10 wt % to 15 wt %) of dimethyl sulfoxide (DMSO) as a vitrification agent to bind the water in a system to be treated, while the DMSO is cytotoxic, affecting the survival rate and function of cells, and then resulting in unsatisfactory clinical results. On the other hand, the vitrified cryopreservation solution can only inhibit the formation of ice crystals during freezing, but cannot control the nucleation and growth of ice crystals during the rewarming, thus leading to large ice crystals in the cells during the rewarming, causing cell damages. Therefore, the development of a safe DMSO-free cryopreservation solution for cells has become a future development trend in the international biomedical field. Although there is a short preservation time of the cold storage, a large number of practices in the field of clinical organ transplantation have confirmed reliability and ease of operation. Accordingly in the foreseeable future, cold storage may still remain a mainstream in the medical application of living cells, tissues, and organs. A core component of the cold storage lies in components and a formula of the cryopreservation solution.

The cellular composition of mammalian tissues and organs is complex and includes multiple types of cells. The tissue preservation solution needs to have a desirable preservation effect on various different types of primary cells. In addition, due to the tight tissue structure, a preservation medium is not easy to penetrate into the cells of the tissue, such that the preservation solution. Moreover, while increasing the tissue permeability of the preservation medium, the spatial structure and morphology of the tissue cannot be destroyed. As a result, tissue preservation is more difficult than cell preservation. The initial tissue preservation solutions were mainly used for organ transplantation and mainly using solutions such as: the Stanford University solution (1988), a modified Collins solution (1990), and the University of Wisconsin solution (1989). The University of Wisconsin (UW) solution is considered an industry standard for organ preservation solutions and has gradually replaced the first two, but there is a limited preservation time provided, with some products only lasting at most 125 min. The preservation solution used in organ transplantation has a short preservation time for tissues. At the same time, the organ preservation solution contains hormone components, such as dexamethasone and prostaglandins, which may stimulate the preserved tissue cells, thereby affecting tissue cells in genetic level, causing changes in gene expression, and affecting detection and research of downstream genes. Some traditional tissue preservation reagents are added with animal-derived proteins, such as bovine serum albumin, which may potentially affect the gene expression of tissue cells.

Existing cryopreservation solutions for cells, tissues, and organs can help lower organ temperature, prevent cell swelling, remove oxygen free radical, reduce ischemic injury, prolong in vitro safe preservation time of organs, and promote organ recovery during reperfusion. However, these cryopreservation solutions still fail to achieve satisfactory results in reducing ischemia-reperfusion injuries (IRIs).

Safe cell cryopreservation solutions require abandoning the use of DMSO, and nature provides people with ideas for research and development. There are many living organisms in nature that can survive in extremely cold environments, such as Ictidomys tridecemlineatus and Mesocricetus auratus (or golden hamster). Both of them are animals that can hibernate and have extraordinary physiological characteristics that allow them to resist ischemia and low temperature. During hibernation, when core temperature drops dramatically, no organ damage has been found in the face of severe and rapid physiological changes. Hibernating animals can sustain iatrogenic injuries such as IRI and energy deprivation outside of the hibernation season, while IRI in humans can lead to organ failure such as organ transplantation and myocardial infarction. Similarly, previous studies have found that cells derived from hibernating animals, such as induced pluripotent stem cells (GS iPSCs) of the Ictidomys tridecemlineatus and hamster liver cells, show significant intrinsic resistance to cold stress. In view of this, based on hibernating animals as a natural model and starting from the stress protection mechanism of hibernating animals, it is hoped that a method can be found to improve cell cryopreservation and cell thawing and effectively reduce cryopreservation damage to the cells or liver tissues.

### SUMMARY

In order to solve the above technical problems, an objective of the present disclosure is to provide a cryopreservation solution and use thereof in reducing an IRI of a cell, a tissue, or an organ. By using innovative exploration mechanisms, it is found that phosphocholine, quinoline-4-carboxylic acid (QCA), and sodium tauroursodeoxycholate (TUDCA) have significant differences during a cryopreservation-rewarming period between hibernating and non-hibernating animals. Based on this, adding the phosphocholine, the QCA, and the TUDCA into a preservation solution to allow cryopreservation of cells, tissues, and/or organs shows a high cell survival rate, can effectively reduce apoptosis caused by cryopreservation-rewarming, reduce mitochondrial reactive oxygen species (ROS), maintain a cell membrane integrity, effectively reduce mitochondrial damage caused by cryopreservation-rewarming, reduce the IRI, and promote liver regeneration. This is of great significance to the advancement of organ transplantation and preservation.

To achieve the above objectives, the present disclosure adopts the following technical solutions:

The present disclosure provides a cryopreservation solution, including any one or more selected from the group consisting of phosphocholine, quinoline-4-carboxylic acid (QCA), and sodium tauroursodeoxycholate (TUDCA).

Further, the cryopreservation solution is prepared by adding the phosphocholine, the QCA, and/or the TUDCA into a basic cryopreservation solution.

Furthermore, the phosphocholine has a concentration of 5 μM to 500 μM, the QCA has a concentration of 2 μM to 200 μM, and the TUDCA has a concentration of 10 μM to 1,000 μM during use.

Further, the basic cryopreservation solution is any one selected from the group consisting of a Hibernate™-A medium, a UW solution, an HTK solution, a Celsior solution, a Collins solution, and an Optisol GS solution.

The Hibernate™-A medium is consisting of: 1800 μM of CaCl2)(anhydrous), 0.2 μM of Fe(NO3)39H2O, 5360 μM of KCl, 812 μM of MgCl2(anhydrous), 76000 μM of NaCl, 880 μM of NaHCO3, 900 μM of NaH2PO4H2O, 0.67 μM of ZnSO47H2O, 25000 μM of D-glucose, 23 μM of phenol red, 10000 μM MOPS, 230 μM of sodium pyruvate, 20 μM L-alanine, 400 μM of L-arginine HCL, 5 μM of L-asparagine H2O, 10 μM of L-cysteine, 500 μM of L-glutamine, 400 μM of glycine, 200 μM of L-histidine HCL H2O, 800 μM of L-isoleucine, 800 μM of L-Leucine, 5 μM of L-lysine HCL, 200 μM of L-methionine, 400 μM of L-phenylalanine, 67 μM of L-proline, 400 μM of L-serine, 800 μM of L-threonine, 80 μM of L-tryptophan, 400 μM of L-tyrosine, 800 μM of L-valine, 8 μM of D-Ca pantothenate, 28 μM of choline chloride, 8 μM of folic acid, 40 μM of i-inositol, 30 μM of niacinamide, 20 μM of pyridoxal HCL, 1 μM of riboflavin, 10 μM of thiamine HCL and 0.2 μM vitamin B12.

The UW solution is consisting of: 30 mmol/L of Raffinose, 100 mmol/L of Lactobionate, 50 g/L of HES (Hydroxyethyl starch), 3 mmol/L of Glutathione, 1 mmol/L of Allopurinol, 5 mmol/L of Adenosine, 5 mmol/L of H2PO4−, 20 mmol/L of HPO42−, 5 mmol/L of Magnesium Sulfate, 30 mmol/L of Na+ and 120 mmol/L of K+.

The HTK solution is consisting of: 15.0 mmol/kg of NaCl, 9.0 mmol/kg of KCl, 4.0 mmol/kg of MgCl2·H2O, 2.0 mmol/kg of Tryptophan, 1.0 mmol/kg of α-ketoglutarate, 30.0 mmol/kg of Mannitol, 180.0 mmol/kg of L-histidine, 18.0 mmol/kg of L-histidine HCl·H2O and 0.015 mmol/kg of CaCl2) (with Osmolality for 295-325; pH adjusted to between 7.0 and 7.2).

The Celsior solution is consisting of: 60 mmol of Mannitol, 80 mmol of Lactobionic Acid, 20 mmol of Glutamic Acid, 30 mmol of Histidine, 0.25 mmol of Calcium Chloride, 15 mmol of Potassium Chloride, 13 mmol of Magnesium Chloride, 100 mmol of Sodium Hydroxide, 3 mmol of Reduced Glutathione and Water for Injection up to 1 liter.

The Collins solution is consisting of: 2.05 g/L of KH2PO4, 9.7 g/L of K2HPO3·3H2O, 1.12 g/L of KCL, 0.84 g/L of NaHCO₃, 0.1.g/L of Procaine HCL, 5000 u/L of Heparin, 0.025 g/L of Phenoxybenzamine, 25 g/L of Glucose and 7.38 g/L of MgSO4·7H2O.

The Optisol GS solution is consisting of: tissue culture medium 199, MEM-Earle Media, N-2-hydroxyethylpiperazine-N-2 ethanesulfonic acid, Gentamicin 25 mg/L, Streptomycin 200 μg/ml, Sodium bicarbonate, Chondroitin sulfate 2.5%, Dextran-T40 1%, Pyruvate, Nonessential aminoacids 0.1 mmol/L, 2-mercaptoethanol, Ascorbic acid, Vitamins, ATP precursors and L-glutamine.

The Hibernate™-A medium can be widely used for the preservation of various cells and tissues for experimental research purposes; the UW solution can be widely used for the preservation of various cell tissues and organs in clinical practice; the HTK solution, the Celsior solution, and the Collins solution are used for the preservation of heart, lung, kidney, and digestive tract tissues and organs; the Optisol GS solution is used for the preservation of cornea and other eye tissues.

The present disclosure further provides use of the cryopreservation solution in cryopreservation of a cell, a tissue, or an organ.

Further, the use includes lowering a temperature of the cell, the tissue, or the organ, preventing swelling of the cell, the tissue, or the organ, removing an oxygen free radical in the cell, the tissue, or the organ, reducing an ischemic injury to the cell, the tissue, or the organ, prolonging an in vitro safe retention time of the cell, the tissue, or the organ, and promoting recovery during reperfusion of the cell, the tissue, or the organ.

Furthermore, the use specifically includes reducing an ischemia-reperfusion injury (IRI) of the cell, the tissue, or the organ.

Furthermore, the cell is a stem cell, the tissue is a liver tissue, and the organ is a liver.

In the present disclosure, hibernating animals are used as natural models to innovatively start from the stress protection mechanism of hibernating animals. Through the lipophilic and hydrophilic metabolomics analysis of the liver grafts from rats, hamsters, and human donors, a candidate list of evolutionarily-conserved metabolites is established to possibly indicate liver recovery after liver transplantation. The analysis found that phosphocholine levels are associated with better liver recovery in patients after liver transplantation. Secondly, it is found that QCA and TUDCA levels are increased during cold acclimatization in hibernating species and then decreased during rewarming, whereas there are no significant differences in those of human hepatocytes between the cold acclimatization and the rewarming period. After research, it is found that if any of the three substances, phosphocholine, QCA, and TUDCA, are added into the cryopreservation solution, human umbilical cord-derived mesenchymal stem cells (hUC-MSCs) and liver tissues can be cold-preserved with a high cell survival rate. Moreover, the cryopreservation solution can also effectively reduce the apoptosis caused by cryopreservation-rewarming, reduce mitochondrial ROS, maintain cell membrane integrity, and effectively reduce the mitochondrial damage caused by cryopreservation-rewarming, thereby reducing IRIs. Specifically, in the case of cold storage of hUC-MSCs, the cryopreservation solution can effectively reduce stem cell death caused by cryopreservation-rewarming, and maintain desirable cell proliferation ability and stem cell characteristics. In the 2 model cases of liver cryopreservation and IRIs, the cryopreservation solution can reduce cryopreservation/rewarming and IRIs, promote liver function recovery, and promote liver regeneration.

Compared with the prior art, the present disclosure has the following beneficial effects:

(1) In the present disclosure, it is found for the first time that in the cryopreservation of hUC-MSCs, using Hibernate™-A medium as a basic cryopreservation solution (control group) and additionally adding phosphocholine, QCA, and TUDCA can effectively reduce cell death caused by cryopreservation-rewarming and maintain a desirable cell proliferation ability.

(2) In the present disclosure, it is found for the first time that in the cryopreservation of liver tissue, the additional addition of phosphocholine, QCA, and TUDCA based on a clinical gold standard preservation solution, UW solution (control group), can effectively reduce hepatocyte apoptosis caused by cryopreservation-rewarming, reduce mitochondrial ROS, maintain hepatocyte membrane integrity, effectively reduce mitochondrial damage caused by cryopreservation-rewarming, reduce IRIs, and promote liver regeneration.

### BRIEF DESCRIPTION OF THE DRAWINGS

FIG. 1 shows the concentration ranges of phosphocholine, QCA, and TUDCA and the types of solvents used in Example 1 of the present disclosure;

FIG. 2 shows the comparison results of light microscopic images of a cell status of MSCs in each treatment group on the second day after cryopreservation for 72 h and then being plated in Example 1 of the present disclosure;

FIG. 3 shows the comparison results of an immediate cell viability of MSCs in each treatment group after cryopreservation for 72 h and a cell number after being plated and cultured for 3 days in Example 1 of the present disclosure;

FIG. 4 shows the comparison results of a cell proliferation ability of MSCs in each treatment group after cryopreservation for 72 h and then being plated in Example 1 of the present disclosure;

FIG. 5 shows the main components of the UW solution in Example 2 of the present disclosure;

FIGS. 6A-6C show the influences of static cold storage (SCS) and rewarming/reperfusion on the liver of rats and hamsters in Example 2 of the present disclosure;

FIGS. 7A-7B show the influences of phosphocholine on hepatocyte mitochondrial ROS and hepatocyte membrane integrity in Example 2 of the present disclosure; and

FIGS. 8A-8C show the changes in rat liver and hepatocyte apoptosis in vitro before and after supplementation of phosphocholine during rewarming/reperfusion in Example 2 of the present disclosure.

### DETAILED DESCRIPTION OF THE EMBODIMENTS

The following examples are intended to illustrate the present disclosure, but not to limit the scope of the present disclosure. Modifications or substitutions made to methods, procedures, conditions, instruments, or reagents of the present disclosure without departing from the spirit and essence of the present disclosure fall within the scope of the present disclosure.

The technical solutions of the present disclosure will be further described in detail below with reference to examples.

### Example 1 Experiment on Cryopreservation of Stem Cells

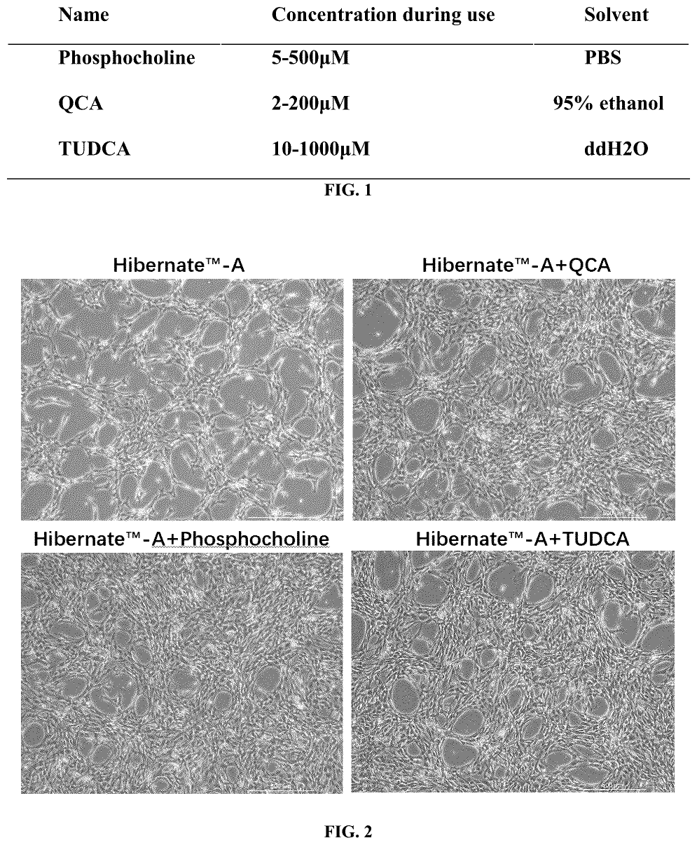

The concentration ranges of phosphocholine (MCE, HY-B2233B), QCA (Macklin, Q817188), and TUDCA (Macklin, S872666) used in this experiment and the types of solvents used were shown in FIG. 1.

Cells used in this experiment were: hUC-MSCs (donated umbilical cord tissues from the Biotherapy Center of the Third Affiliated Hospital of Sun Yat-sen University and newborns).

The number of cells used in this experiment was: 1×10⁶ cells.

The basic cryopreservation solution used in this experiment was Hibernate™-A medium (Thermofisher, catalog number: GIBCO A1247501), and the components were shown in Table 1.

TABLE 1
Components in Hibernate ™-A medium

| | | |
|---|---|---|
| NaCl | 76000 | μM |
| CaCl₂ | 1800 | μM |
| Fe(NO₃)₃ | 0.25 | μM |
| KCl | 5360 | μM |
| Mgcl₂ | 812 | μM |
| NaHCO₃ | 880 | μM |
| NaH₂PO₄ | 906 | μM |
| ZnSO₄ | 0.67 | μM |
| D-Ca Pantothenate | 8 | μM |
| Folic acid | 8 | μM |
| Niacinamide | 30 | μM |
| Pyridoxal | 20 | μM |
| Riboflavin | 1 | μM |
| Thiamine | 10 | μM |
| B12 | 0.2 | μM |
| D-Glucose | 25000 | μM |
| Phenol Red | 23 | μM |
| MOPS | 10000 | μM |
| Sodium Pyruvate | 227 | μM |
| Choline Chloride | 28 | μM |
| I-Inositol | 40 | μM |
| L-Alanine | 22 | μM |
| L-Arginine | 483 | μM |
| L-Asparagine | 5.5 | μM |
| L-Cysteine | 7.7 | μM |
| L-Glycine | 400 | μM |
| L-Histidine | 200 | μM |
| L-Isoleucine | 802 | μM |
| L-Leucine | 802 | μM |
| L-Lysine | 798 | μM |
| L-Methionine | 201 | μM |
| L-Phenylalanine | 400 | μM |
| L-Proline | 67 | μM |
| L-Serine | 400 | μM |
| L-Threonine | 798 | μM |
| L-Tryptophan | 78 | μM |
| L-Tyrosine | 398 | μM |
| L-Valine | 803 | μM |

| | |
|---|---|
| PH | 6.8-7.2 |
| Osmotic pressure | 235 +/− 5 mOsm |

The experimental groups of this example included: Hibernate™-A, Hibernate™-A+TUDCA, Hibernate™-A+QCA, and Hibernate™-A+Phosphocholine.

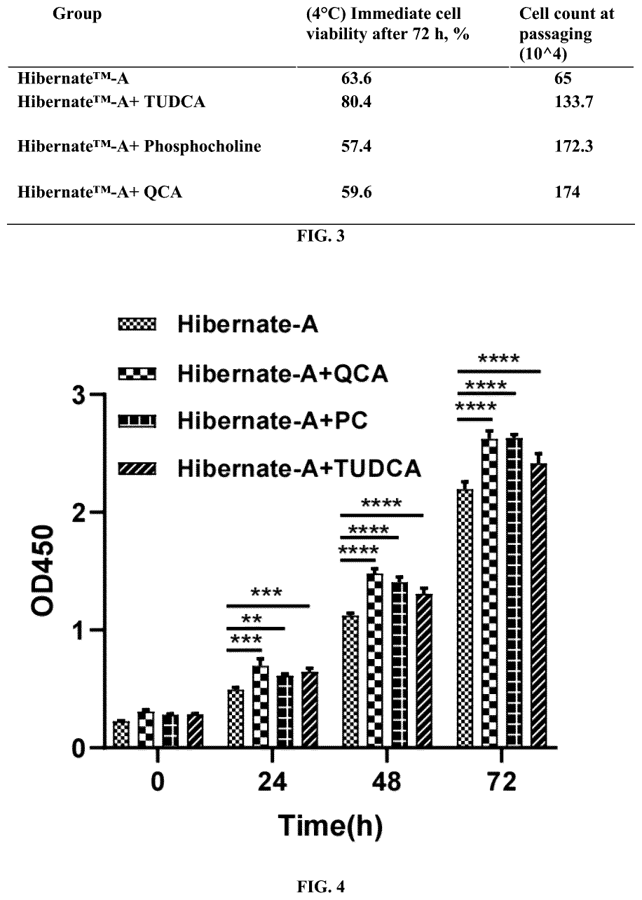

The experimental operation of this example included: 1 mL of the resuspended hUC-MSCs cells in Hibernate™-A basic cryopreservation solution with the above-mentioned specified metabolites added were placed in a 5 mL EP tube, allowed to stand at room temperature for 20 min, and then placed in a 4° C. refrigerator shaker for slow shaking to allow cryopreservation for 72 h. After cryopreservation for 72 h, the cells were centrifuged and counted with trypan blue to calculate the cell survival rate, and then plated on a 96-well plates for CCK8 cell proliferation assay. The remaining cells were continued to be plated on a 6-well plate and placed in a 37° C. cell culture incubator to observe the subsequent cell status. FIG. 2 showed the comparison results of light microscopic images of a cell status of MSCs in each treatment group on the second day after cryopreservation for 72 h and then being plated. FIG. 3 showed the comparison results of an immediate cell viability of MSCs in each treatment group after cryopreservation for 72 h and a cell number after being plated and cultured for 3 days. FIG. 4 showed the comparison results of a cell proliferation ability of MSCs in each treatment group after cryopreservation for 72 h and then being plated, which were detected by CCK8 cell proliferation experiment.

FIG. 2 showed that the cell growth state of hUC-MSCs cultured after adding the above three metabolites to the basic cryopreservation solution for 72 h was significantly better than that of the basic cryopreservation solution control.

FIG. 3 showed that the immediate cell survival rate of hUC-MSCs in TUDCA added basic cryopreservation solution after 72 h of cryopreservation was significantly higher than that of the basic cryopreservation solution control, and the total number of cells obtained after being plated and cultured for 3 days was significantly more than that of the basic cryopreservation solution control. The immediate cell survival rates of hUC-MSCs in phosphocholine and QCA added basic cryopreservation solution after 72 h of cryopreservation were slightly lower than that of the basic cryopreservation solution control, but the total number of cells obtained after being plated and cultured for 3 days of was significantly more than that of the basic cryopreservation solution control. This suggested that the TUDCA was mainly focused on the protection of cells during cryopreservation, while phosphocholine and QCA mainly played a role in protecting cells from rewarming stress after cryopreservation.

FIG. 4 showed that the cell proliferation rate of hUC-MSCs in the above three metabolites added basic cryopreservation solution after cryopreservation for 72 h was significantly higher than that of the basic cryopreservation solution control.

### Example 2 Experiment on Cryopreservation of Liver and Hepatocytes

### 1. Experimental Procedures of SCS and Rewarming/Reperfusion in Rat and Hamster Livers

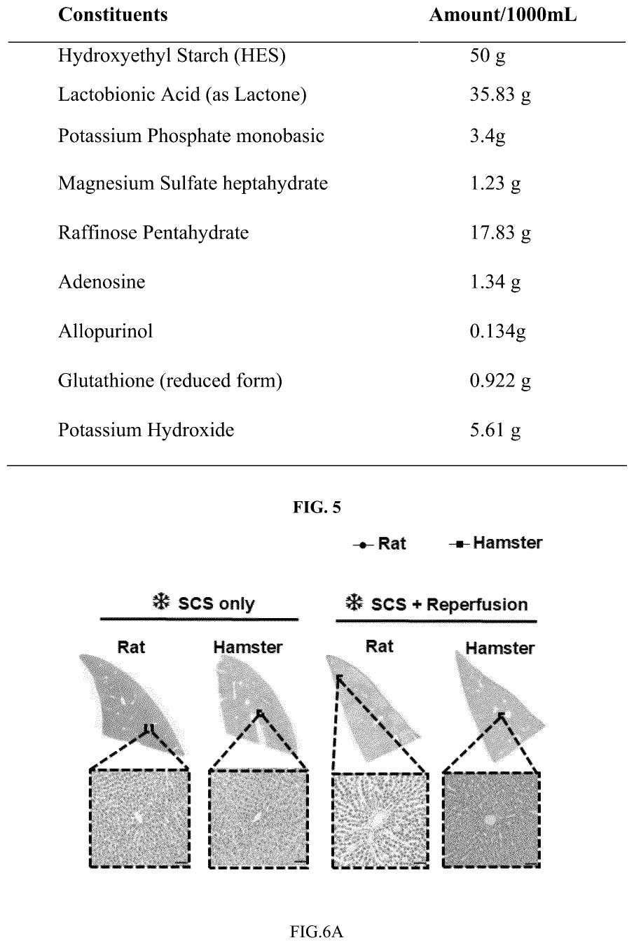

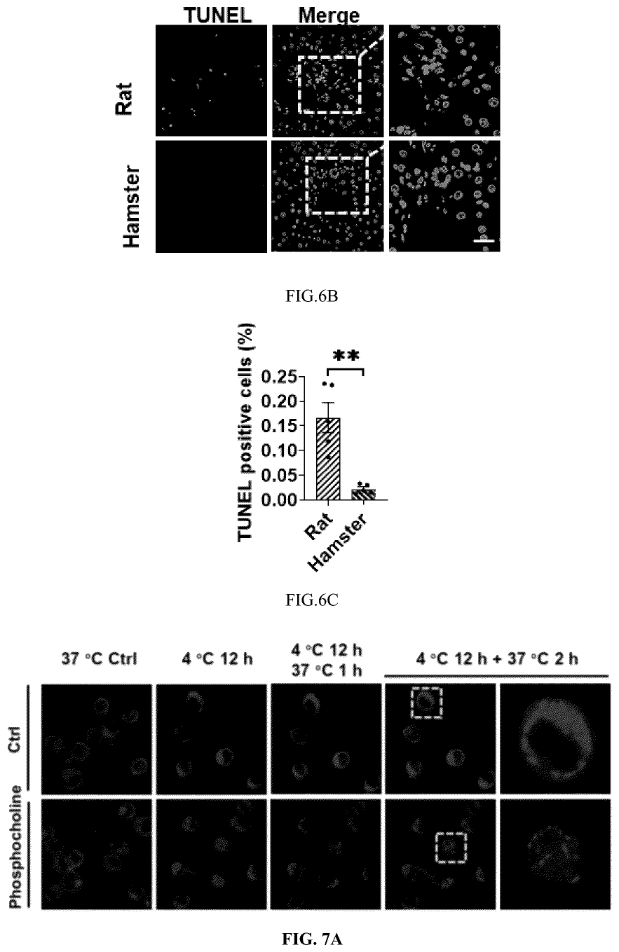

2-3 month old male/female SD rats or 2-3 month old golden hamsters were fasted overnight and anesthetized by inhalation of isoflurane, and then given 50 IU of heparin. The bile duct was cannulated with a PE-10 catheter, and the portal vein was cannulated with a 22-G Introcan catheter. The liver was washed with physiological saline, UW, or UW supplemented with phosphocholine (50 μM) and collected. A perfusion system was established in a circulation mode, and 250 mL of a Krebs-Henseleit (KH) bicarbonate buffer or KH buffer supplemented with phosphocholine (500 μM) was prepared. Oxygenation was conducted in a mixed gas of 95% O₂ and 5% CO₂ through a fiber oxygenator to a partial pressure of oxygen exceeding 500 mmHg. The liver was stored at 4° C. for 48 h, equilibrated at room temperature for 10 min, and perfused at 37° C. for 2 h. A flow rate was set in pressure control mode, and a portal vein pressure (PVP) was kept constant at 12 mmHg. The flow rate and PVP were automatically monitored and recorded. The portal vein resistance (PVR) was calculated as follows: PVR (mmHg/mL×min×g liver)=PVP (12 mmHg)/portal vein flow rate (mLxminxg liver). Liver samples were fixated in 4% paraformaldehyde for subsequent H&E sectioning and TUNEL staining. The main components of the UW solution were shown in FIG. 5. The liver H&E sections and TUNEL staining showing comparison of influences of the SCS and rewarming/reperfusion on the liver of rats and hamsters were shown in FIGS. 6A-6C.

The results showed that rewarming/reperfusion had a significant influence on the hepatic sinusoidal space and hepatocyte morphology of rat liver, but had no influence on hamster liver; TUNEL staining showed a large number of apoptotic cells in rat liver, but there was no influence on hamster liver. This suggested that hamster liver showed a stronger ability to adapt to cold.

### 2. Experimental Procedures of Cryopreservation of Hepatocytes

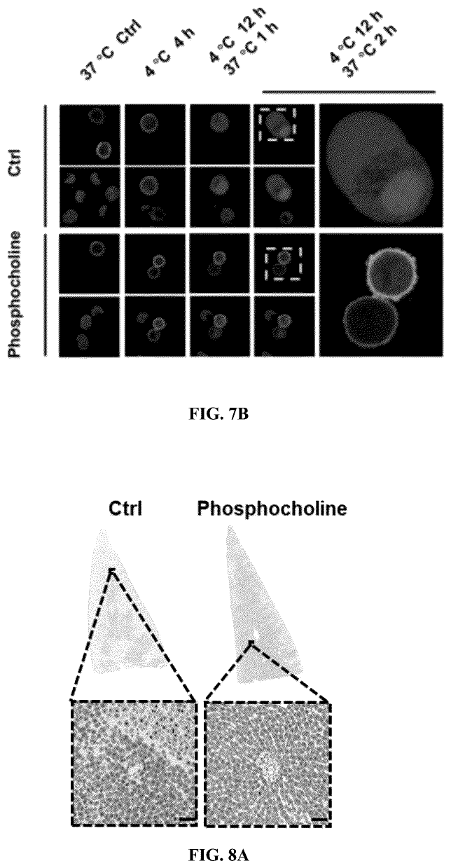

Hepatocytes cultured under normal conditions served as a 37° C. control. For cold exposure treatment, the medium was replaced with UW solution at room temperature for 15 min, and the cells in UW solution (containing 50 μM phosphocholine) were transferred to a 4° C. refrigerator for 12 h. Rewarming involved taking cells out of the refrigerator and culturing with a pre-chilled medium (containing 500 μM phosphocholine). After allowing to stand for 15 min at room temperature, the cells were transferred to a 37° C. incubator for 2 h. The integrity of cell membranes is dynamically monitored by Real-time imaging using MitoNeoD live cell dye to assess the mitochondrial ROS and transfection of a plasmid carrying the mNeonGreen tag and the phospholipase Cδ PH domain. The results were shown in FIGS. 7A-7B.

The results showed that phosphocholine could reduce ROS in hepatocyte mitochondria and maintain the integrity of hepatocyte membrane.

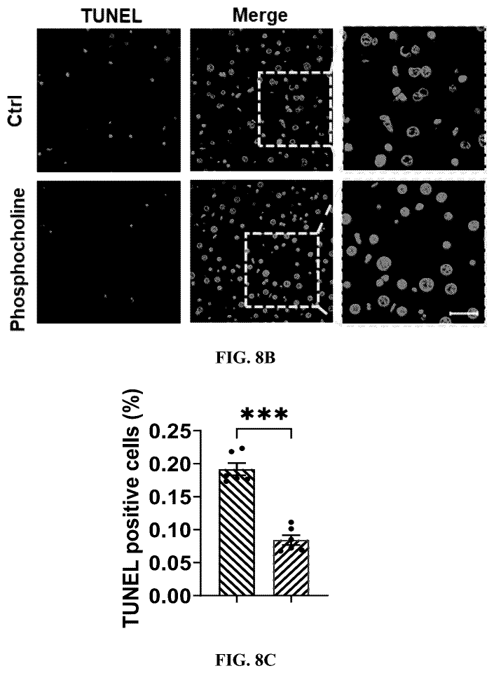

3. FIGS. 8A-8C showed the changes in rat liver and hepatocyte apoptosis in vitro before and after supplementation of phosphocholine during rewarming/reperfusion observed by H&E sectioning and TUNEL staining.

The results showed that after supplementation of phosphocholine in isolated rat liver during rewarming/reperfusion, the sinus cavity was apparently normal and cell apoptosis was milder than that in the control group.

The above examples are only intended to describe the preferred implementations of the present disclosure, but not to limit the scope of the present disclosure. Various alterations and improvements made by those of ordinary skill in the art based on the technical solution of the present disclosure without departing from the design spirit of the present disclosure shall fall within the scope of the appended claims of the present disclosure.

What is claimed is:

1. A cryopreservation solution, comprising quinoline-4-carboxylic acid (QCA), wherein the cryopreservation solution is prepared by adding the QCA into a basic cryopreservation solution; the QCA has a concentration of 2 μM to 200 μM during use; and the basic cryopreservation solution is any one selected from the group consisting of a Hibernate™-A medium, a UW solution, an HTK solution, a Celsior solution, a Collins solution, and an Optisol GS solution.

2. Use of the cryopreservation solution according to claim 1 in cryopreservation of a cell, a tissue, or an organ.

3. The use according to claim 2, comprising lowering a temperature of the cell, the tissue, or the organ, preventing swelling of the cell, the tissue, or the organ, removing a reactive oxygen species (ROS) in the cell, the tissue, or the organ, reducing an ischemic injury to the cell, the tissue, or the organ, prolonging an in vitro safe retention time of the cell, the tissue, or the organ, and promoting recovery during reperfusion of the cell, the tissue, or the organ.

4. The use according to claim 2, specifically comprising reducing an ischemia-reperfusion injury (IRI) of the cell, the tissue, or the organ.

5. The use according to claim 3, wherein the cell is a stem cell.

6. The use according to claim 3, wherein the tissue is a liver tissue.

7. The use according to claim 3, wherein the organ is a liver.

8. The use according to claim 5, specifically comprising reducing an ischemia-reperfusion injury (IRI) of the cell, the tissue, or the organ.

9. The use according to claim 6, specifically comprising reducing an ischemia-reperfusion injury (IRI) of the cell, the tissue, or the organ.

10. The use according to claim 7, specifically comprising reducing an ischemia-reperfusion injury (IRI) of the cell, the tissue, or the organ.
